(19) United States
(12) Patent Application Publication
(10) Pub. No.: US 2009/0158218 A1
(43) Pub. Date: Jun. 18, 2009

(54) Structured model navigator

(75) Inventors: Robert W. Brooks, Owego, NY (US); David C. Cowles, Waverly, NY (US); Joseph R. Grosso, Endicott, NY (US)

Correspondence Address: MICHAEL BEST & FRIEDRICH LLP, 100 E WISCONSIN AVENUE, Suite 3300, MILWAUKEE, WI, 53202, US

(73) Assignee: Lockheed Martin Corporation, Bethesda, MD (US)

(21) Appl. No.: 12/151,006

(22) Filed: May 2, 2008

Related U.S. Application Data
(60) Provisional application No. 60/915,999, filed on May 4, 2007.

(51) Int. Cl. G06F 7/06; G06F 17/30; G06F 3/048

(52) U.S. Cl. 715/854; 707/5; 707/102; 707/103 R; 707/E17.005; 707/E17.047; 707/E17.055; 707/E17.016

(57) ABSTRACT

A system for organizing and searching data that relates to a product of manufacture includes a database module configured to store values for a plurality of attributes for each of a plurality of components. A portion of the plurality of components is employed in the product of manufacture. A processing module is configured to organize the plurality of components into one of a plurality of user selectable product structures. Each product structure is based on the values of one of the plurality of attributes. A display is configured to display the selected product structure of the article of manufacture with each of the components displayed within the selected structure.

### RELATED APPLICATION DATA

The present application claims the benefit of co-pending provisional patent application Ser. No. 60/915,999, filed May 4, 2007, the subject matter of which is hereby fully incorporated by reference.

### BACKGROUND

The present invention relates to a structured model navigator. More particularly, the invention relates to a computer program that facilitates the organization and searching of structured model data in various ways according to the user.

Manufacturing and construction of complex systems (e.g., aircraft, automobiles, ships, buildings, new facilities, etc.) requires the use of large quantities of data. For example, nearly every component employed in such systems is part of a subassembly and includes a drawing, a material specification, a manufacturing process, etc. Generally, the data is arranged in a structured list based on the sub-assemblies or through some other listing of components.

While a bill of materials type listing is suitable for use for some users, other users are interested in other features or attributes of the various components. These people must often reorganize the data to suit their needs. However, to reorganize the data, the users must take a copy of the data at a particular time and then manipulate that data. In doing this, the data becomes disconnected from other groups or people who may manipulate the data, thereby resulting in potentially out-of-date and incorrect data.

### SUMMARY

In one construction, the invention provides a system for organizing and searching data that relates to a product of manufacture. The system includes a database module configured to store values for a plurality of attributes for each of a plurality of components. A portion of the plurality of components is employed in the product of manufacture. A processing module is configured to organize the plurality of components into one of a plurality of user selectable product structures. Each product structure is based on the values of one of the plurality of attributes. A display is configured to display the selected product structure of the article of manufacture with each of the components displayed within the selected structure.

In another construction, the invention provides a method of interacting with data related to components that are used to assemble an article of manufacture. The method includes establishing a database including data describing a plurality of components used to assemble the article of manufacture, assigning a value to each of a plurality of attributes for each of the plurality of components, and organizing the components into a structure based on the values of one of the plurality of attributes. The method also includes displaying the structure in a hierarchal fashion based on the one of the plurality of attributes.

In still another construction, the invention provides a graphical user interface configured to be displayed on a computer system for informing a user about selected search results of data related to an article of manufacture. The graphical user interface includes a search results view pane including a drop down list of user selectable views for selecting a results view and a search pane including a plurality of search criteria windows for the user to input search criteria. A search results pane displays search results arranged in a view based on the user selectable view selected in the search results view pane.

### BRIEF DESCRIPTION OF THE DRAWINGS

FIG. 1 is a low level component diagram embodying the invention;

FIG. 2 is a screenshot of a home screen for a structured model navigator embodying the invention;

FIG. 3 is a screenshot of the home screen of FIG. 2 after the selection of a node;

FIG. 4 is a screenshot of the home screen of FIG. 2 after the selection of a node and including an expanded available model structures area;

FIG. 5 is a screenshot of a search view window;

FIG. 6 is a screenshot of the search view window of FIG. 5 including search results arranged in a list;

FIG. 7 is a screenshot of the search view window of FIG. 5 including search results arranged in a tree structure;

FIG. 8 is a screenshot of an export view;

FIG. 9 is a screenshot of the details portion of the home screen of FIG. 3;

FIG. 10 is an activity diagram illustrating a top-level program flow for the structured model navigator;

FIG. 11 is a class diagram that lists the lowest level code module (class) names and diagrams their interaction;

FIG. 12 is a sequence diagram showing the detailed flow through the structured model navigator;

FIG. 13 is a diagram illustrating the concept of an unstructured set of model data having attributes associated with it being incorporated into a structure;

FIG. 14 is a screenshot of a home screen including model data arranged by functional product structure and including detail data;

FIG. 15 is a screenshot of a home screen including model data arranged by logistic control number (LCN) and including detail data;

FIG. 16 is a screenshot of a portion of the home screen of FIG. 2 with the model structure arranged by functional product structure;

FIG. 17 is a screenshot of a portion of the home screen of FIG. 2 with the model structure arranged by logistic control number (LCN);

FIG. 18 is a screenshot of a portion of the home screen of FIG. 2 with the model structure arranged by group code; and

FIG. 19 is a screenshot of a portion of the home screen of FIG. 2 with the model structure arranged by system interfaces.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, a “model” is a collection of elements that are related to each other in one or more distinct structures. A “structure” is a hierarchical arrangement of a number of elements in a model and an “element” is a single model entity that has a name, type and set of attributes. An “attribute” is a single characteristic of data, defined by a categorization, name and value (e.g., drawing number, part number, control number, material, manufacturing process, criticality classification, loading parameters, etc.).

In one example, a product of manufacture such as an aircraft is the system being modeled. The aircraft includes multiple structures with each structure including many elements and each element having at least one attribute. Depending on the users' discipline or job duties, they may want to sort the model based on different attributes of the data. For example, if the user is responsible for purchasing raw material, they may want to sort the data based on an attribute that identifies the material used for various elements. The user purchasing raw material is not concerned with the structural significance, location, or control number for the various elements. In another example, the user could be a project manager looking to reduce the cost or weight of the system. This user may want the data sorted by a cost or weight attribute. This allows the project manager to quickly identify the most expensive or heaviest elements rather than having to search through a bill of materials or other listing of components to try and find the cost or weight data.

In addition, the term “structured model navigator” or “navigator” should be understood to include a computer program, set of instructions, and/or machine executable program, such as a database module (stored in any type of memory such as but not limited to volatile, non-volatile, flash, EEPROM, PROM, optical, magnetic, or other memory types) capable of performing the functions described herein. In a preferred implementation, the navigator is run on a server or networked group of computers, that include a processing module and a display, and/or is accessible via a secured or unsecured Internet server. In some constructions, the navigator is implemented within a Web Portal environment that offers native support for secure access across the Internet. In a preferred construction, the program is written using JAVA.

In various practical disciplines, the analysis of organized structures of data is critical to success. However, the maintenance of distinct organizations of fundamentally identical data is cumbersome and riddled with data integrity issues. A flexible mechanism that separates the inter-relationships of data elements from the definition of those elements is needed.

When operating with data that is shared among different work groups with differing responsibilities, it is difficult to assign a clear administrator that maintains the data. The limit of growing data sets is that a group of people must be solely dedicated to the maintenance of the data sets. Furthermore, a mechanism should exist where common elements can be shared between the groups, but that still allows each group to attach attributes relevant to its responsibilities.

Beyond the size of the model for some complex systems (e.g., aircraft, automobiles, ships, buildings, new facilities, etc.), the maintenance problems are compounded by the fact that many structures are organized by discrete inclusion and relational rules. These rules are typically based on data already associated with elements. Without a mechanism to compute these “rule-based” structures from the raw model data, an organization is left with the tedious and error-prone task of manually sifting and resorting data based on those rules. Furthermore, each and every time an element is modified those same rules must be reevaluated to ensure the structures remain accurate.

Organizing the data does not solve all of the problems when working with complex systems. The significant number of system components makes searching through an ordered list tedious. As such, a searching system or search module is also needed. Once a model of the data organization is obtained, typical search mechanisms return unstructured lists of search matches (“hits”). In addition, most search mechanisms only search across all elements, without the context of the structures those elements are grouped in. This, unfortunately, loses the structured context of the data. A mechanism that permits the scope of a search to be constrained to a particular structure would offer numerous advantages to understanding the scope of a particular element.

The navigator (sometimes referred to as the solution) offers the capability to present a model with any number of associated structures and elements and can support the display of any number of categorized attributes associated with model elements. The navigator provides search capabilities that offer both the classic search listing as well as a unique structured representation that illustrates the structured context of the search results. The structured representation permits the user to navigate through a structure while being provided indications of where the actual search result is located within the structure, what areas of the structure contain search results, and what areas contain no results.

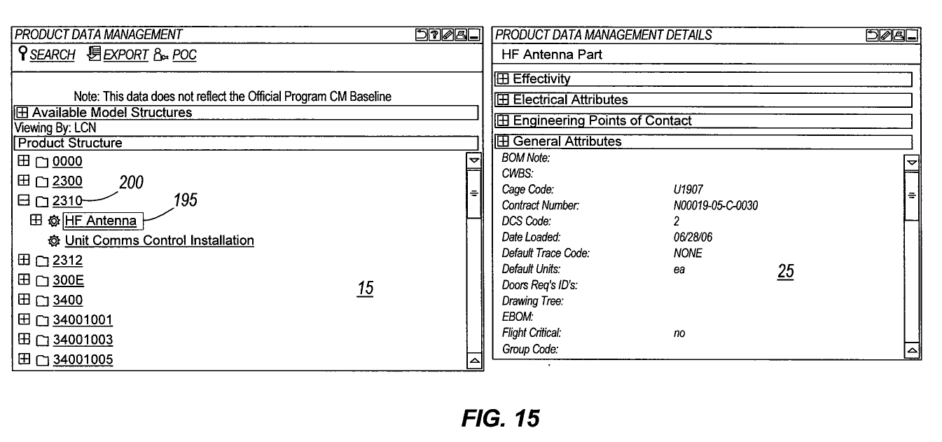

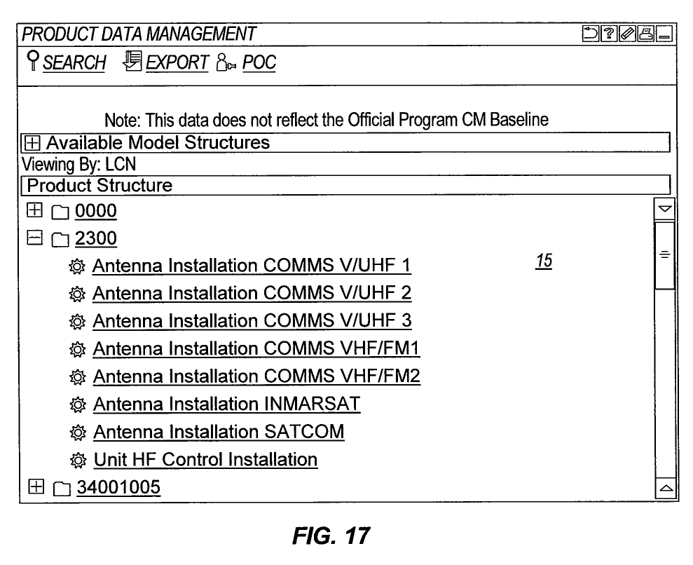

The navigator is able to present a variety of different tree structures of the data. The data is grouped or organized by business rules and then the groups are displayed. For example, the data may be grouped by LCN and then displayed in a structure that is arranged by LCN (see FIGS. 15 and 17). In some constructions, the user can input a user inclusion rule that is then used as the basis of a search and/or to organize the data. The inclusion rule may rely on the values of one attribute or a combination of values from two or more attributes. In still other systems, the inclusion rule is built based on values of one or more attributes and non-attribute data. The inclusion rule can be built and saved as a user-selectable structure. For example, a user may wish to display a structure arranged based on the location of the component on the finished product. Thus, for an aircraft, the data might be arranged under forward components, aft components, starboard components, port components, and cabin components. While the location of the component is not a value of any attribute, it can be used to build the structure. To speed the operation of the system, the structures are pre-built and stored so that they do not have to be rebuilt each time a user selects a different structure for display. This is one of the true advantages of the navigator, in the sense that in addition to supporting different organizations of the data, the actual objects remain the same no matter where they are presented.

The user interface is implemented separate from the database that contains the actual data. Thus, the data is stored in a relational database and the navigator uses the relational database to scale to large models. The navigator also maintains the elements distinct from the structures to ensure that each time an element is associated in a structure, it is consistent. The navigator can retain any number of attributes to be associated with elements. In addition, the navigator provides search mechanisms for searching within structures as well as classical search result listing. The navigator indexes all data within the model to provide efficient and fast searches and provides the capability to use rules to compute structures. In addition, the navigator can be extended to accommodate many different rules to compute structures as well as support manually defined structures.

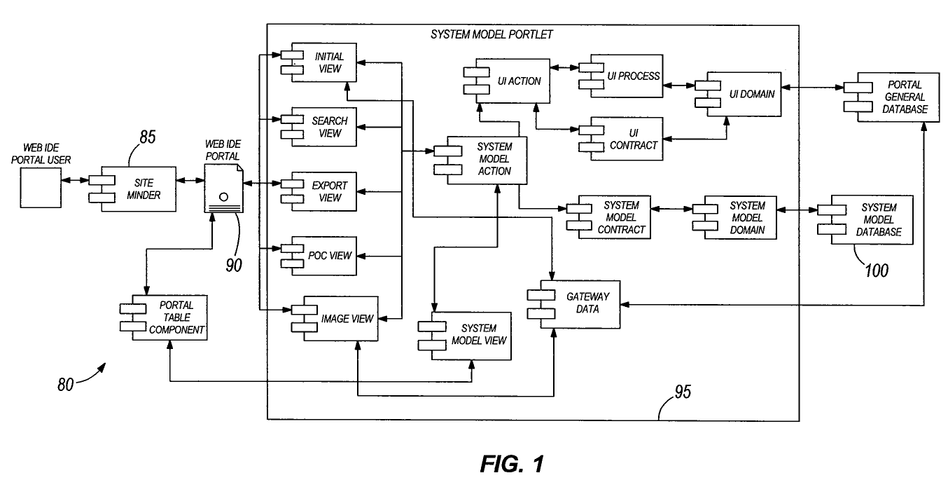

Before proceeding with the description of FIGS. 1-19, it should be noted that many of the figures illustrate exemplary data related to an aircraft. However, one of ordinary skill in the art will realize that many other systems could be modeled using the navigator described herein.

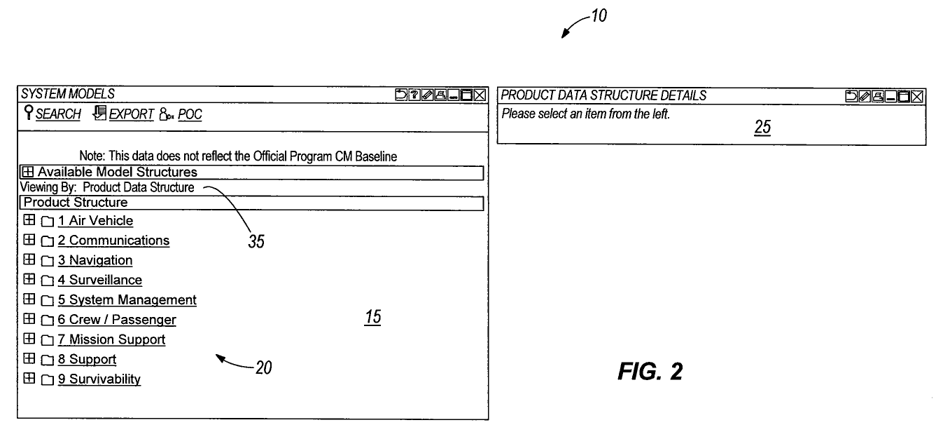

Turning to FIG. 2, an image of a home screen 10 of a graphical user interface is shown. The screen is divided into a pair of portlets. The portlet 15 on the left provides the default tree structure 20 for the data being analyzed and the right portlet 25 displays details for a selected node 30 or element. The details portlet 25 is initially empty as no node or element has yet been selected.

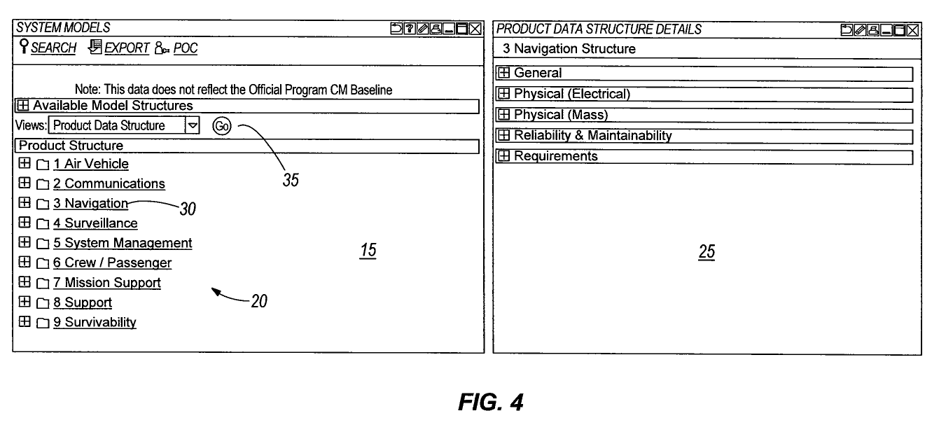

The left portlet 15 includes an available model structures area 35 that is collapsed and allows the user to select the desired tree structure 20. As illustrated in FIG. 2, the navigator starts in a user-selectable default arrangement (e.g., product data structure). FIG. 4 illustrates the available model structures area 35 in an expanded state. As can be seen, a drop down list is provided to allow a user to select the desired model structure for viewing. Some of the available model structures include but are not limited to functional product structure, logistic control number, group code, system interfaces, etc.

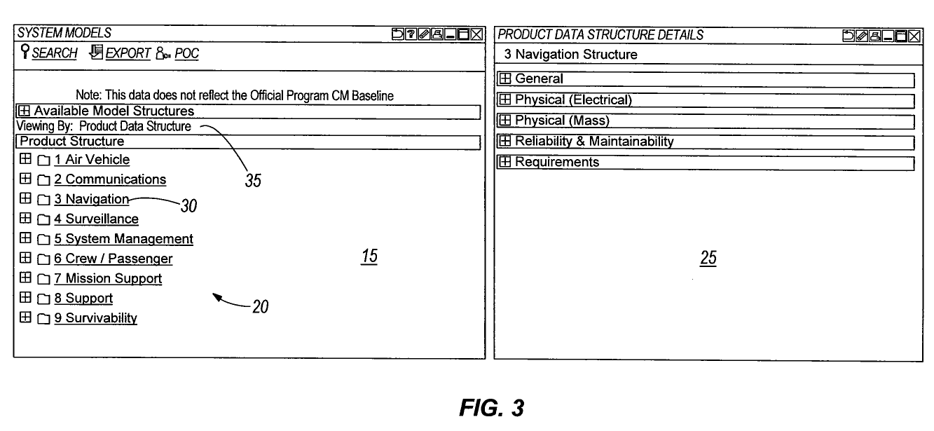

FIG. 3 illustrates the model structure of FIG. 2 after a user has selected one of the nodes 30. Specifically, the user has selected the Navigation node 30. The details of the Navigation node are now displayed in the right hand portlet 25. As can be seen, the user has the ability to “drill down” or navigate through any of the nodes in the left or right portlet 15, 25 as may be desired.

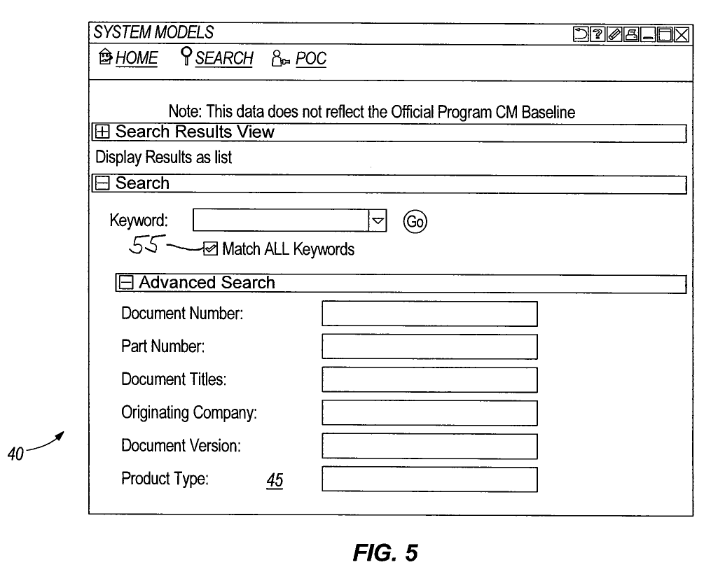

FIG. 5 illustrates a default screen for the search view 40 or search pane. The search view screen 40 includes an advanced search region 45 or pane that is expandable or collapsible. In the illustrated construction, the advanced search region 45 allows the user to search by title, originating company, document version, and/or product type with other advanced search criteria also being possible. The search view screen 40 also includes a collapsible search results view pane 50 that allows the user to select a list or a structure to format his or her search results. A match all keywords check box 55 is displayed and initially checked. When a search is performed with this option checked, only those results that match all the keywords will be returned. Keywords do not need to match within the same attribute, however. If unchecked, the search will return any results that match any of the space-delimited keywords. It should be noted that additional search features could be added to the search view 40 if desired. For example, one construction adds a field to allow the user to set the maximum number of results for a search. In this construction, a message is provided if the search results exceed that predefined number to alert the user that the search results displayed are not complete.

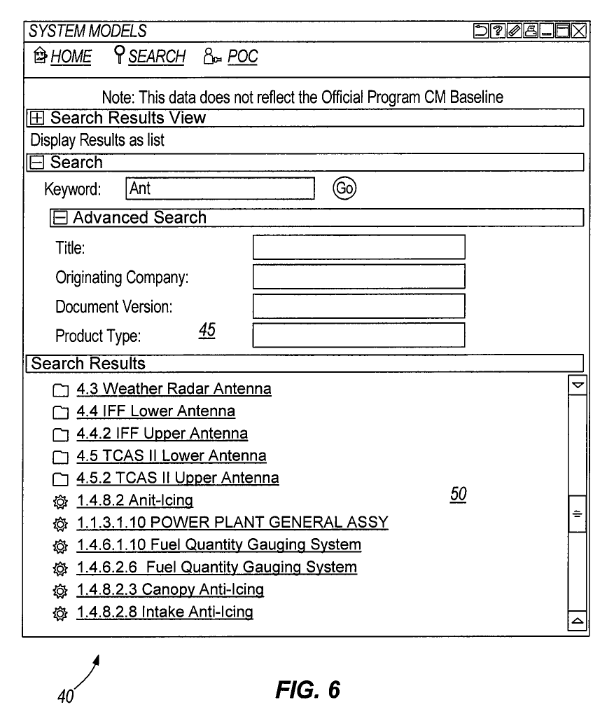

FIG. 6 illustrates the search view screen 40 of FIG. 5 following a keyword search for “ant”. As can be seen, the search results are displayed in the lower portion of the window, in a search results pane, and are formatted in a list as was selected in FIG. 5.

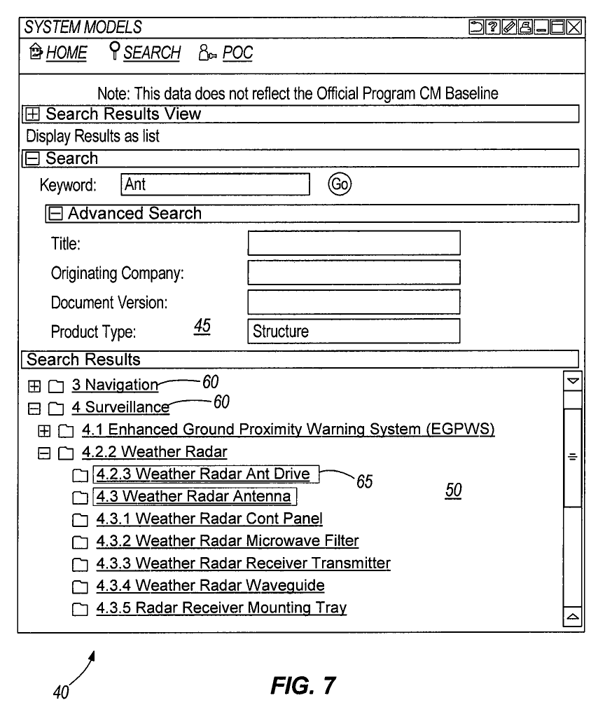

FIG. 7 illustrates a search similar to that of FIG. 6. Specifically, the search of FIG. 7 was limited to the keyword “ant” and to a product type of “structure”. In addition, the search results are displayed in a tree structure rather than the simple list. The tree structure arrangement provides additional structure for the user by showing not only the search results but high level relationships for those results.

In the results section, nodes that include a search result or hit 60 are italicized or otherwise identified. This allows the user to navigate into the structure until a highlighted element 65 appears. The highlighted or otherwise identified element 65 is the actual search result or hit.

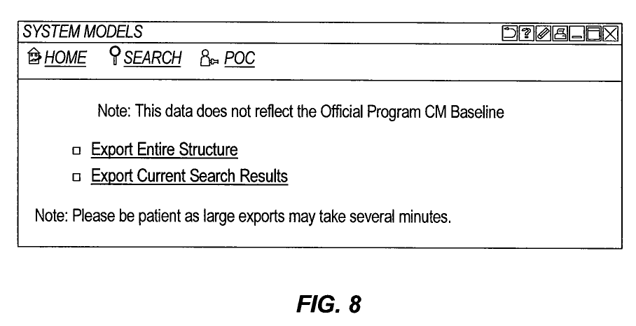

As illustrated in FIG. 8, the navigator includes an export feature that allows the user to export data to MICROSOFT EXCEL or to other data management programs as may be desired. Generally, the entire structure or the search results alone can be exported. Once exported, the data is no longer part of the active model and as such, any changes made to the active data will not be made to the exported data.

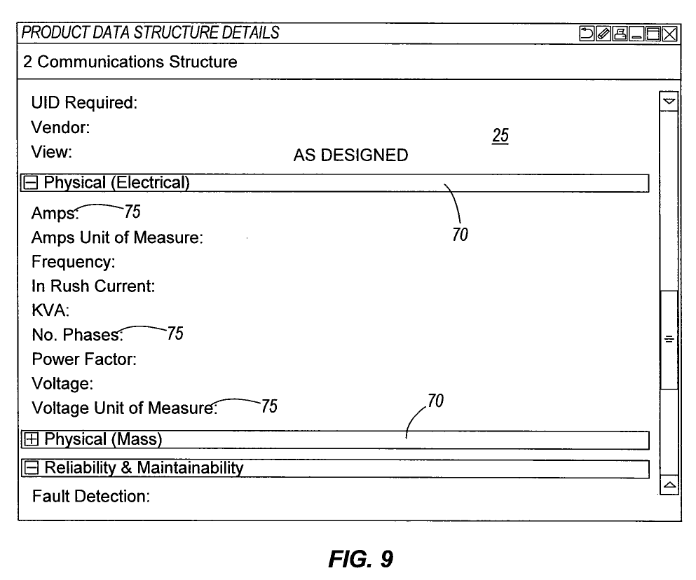

FIG. 9 illustrates a portion of a details view 25 of the Communications node of FIG. 2. Within the details view 25 are a series of collapsible categories 70 that further aid in sorting the data. Within each category 70 is a series of attributes 75 that is sorted alphabetically. This arrangement allows a user to quickly find the desired attribute 75 by drilling down through the desired category 70. In other constructions, the categories 70 may be eliminated such that the attributes 75 are listed alphabetically without categorization. Many different attributes 75 can be included in each category 70. Table A lists some possible attributes 75 and their respective categories 70. Of course, additional attributes 75 could be employed if desired.

| Category | Attribute |
|---|---|
| (BLANK) | Description |
| (BLANK) | Diagram Status |
| (BLANK) | Document |
| (BLANK) | Document Details |
| (BLANK) | Fixed Time |
| (BLANK) | From Unit of Behavior |
| (BLANK) | Glossary Text |
| (BLANK) | Identifies |
| (BLANK) | Image Link |
| (BLANK) | Initial Audit |
| (BLANK) | Initial Date |
| (BLANK) | Initial Time |
| (BLANK) | Last Change Audit |
| (BLANK) | Last Change Date |
| (BLANK) | Last Change Time |
| (BLANK) | Milestone |
| (BLANK) | Number |
| (BLANK) | Summary Task |
| (BLANK) | Time Measure |
| (BLANK) | To Unit of Behavior |
| (BLANK) | Update Date |
| (BLANK) | Used By |
| Effectivity | Vehicle 1 |
| Effectivity | Vehicle 2 |
| Effectivity | Vehicle 3 |
| Electrical Attributes | Amps |
| Electrical Attributes | Amps Unit of Measure |
| Electrical Attributes | Frequency |
| Electrical Attributes | In Rush Current |
| Electrical Attributes | KVA |
| Electrical Attributes | No. Phases |
| Electrical Attributes | Power Factor |
| Electrical Attributes | Voltage |
| Electrical Attributes | Voltage Unit of Measure |
| Engineering Points | Subsystem Software |
| of Contact | Engineering Lead |
| Engineering Points | Subsystem Systems |
| of Contact | Engineering Lead |
| Engineering Points | Subsystem Test |
| of Contact | Engineering Lead |
| eSID Attributes | 3rd Party Proprietary |
| | Information |
| eSID Attributes | AECI Numbers |
| eSID Attributes | Critical Program |
| | Information |
| eSID Attributes | Customer Deliverable |
| eSID Attributes | Export Control |
| eSID Attributes | For Official Use Only |
| eSID Attributes | Lockheed Martin |
| | Proprietary Information |
| General Attributes | (Location) Folder Path |
| General Attributes | Applicable Flight |
| | Clearances |
| General Attributes | BOM Note |
| General Attributes | Cage Code |
| General Attributes | Contract Number |
| General Attributes | CWBS |
| General Attributes | Date Loaded |
| General Attributes | DCS Code |
| General Attributes | Default Trace Code |
| General Attributes | Default units |
| General Attributes | Document Author |
| | Custodian |
| General Attributes | Document Description |
| General Attributes | Document Iteration |
| General Attributes | Document Life Cycle |
| | State |
| General Attributes | Document Name |
| General Attributes | Document Number |
| General Attributes | Document Title |
| General Attributes | Document Type |
| General Attributes | Document TypeDef |
| General Attributes | Document Version |
| General Attributes | Doors Req's ID's |
| General Attributes | Drawing Tree |
| General Attributes | EBOM |
| General Attributes | File(Local) |
| General Attributes | Flight Critical |
| General Attributes | Group Code |
| General Attributes | Item Find Number |
| General Attributes | Job Authorization |
| | Number |
| General Attributes | LCN |
| General Attributes | Legacy Drawing Rev |
| General Attributes | Legacy Selected Item |
| | Code |
| General Attributes | Lifecycle |
| General Attributes | Module |
| General Attributes | National Stock Number |
| General Attributes | Nomenclature |
| General Attributes | Organization(Cage) |
| General Attributes | Originating Company |
| General Attributes | Part Level |
| General Attributes | Part Master Planning |
| | Code |
| General Attributes | Part Number |
| General Attributes | Product Name |
| General Attributes | Product Type |
| General Attributes | Quantity |
| General Attributes | Reference Designator |
| General Attributes | Replacement Product |
| General Attributes | Repository/ProductLine |
| General Attributes | Revision |
| General Attributes | Segment |
| General Attributes | Source |
| General Attributes | State |
| General Attributes | Structure Level |
| General Attributes | Subsystem |
| General Attributes | Symbol Code |
| General Attributes | System |
| General Attributes | Team |
| General Attributes | Type |
| General Attributes | Type Designator |
| General Attributes | UID |
| General Attributes | UID Required |
| General Attributes | Vendor Name |
| General Attributes | View |
| General Attributes | WUC-POS |
| Kits | Kit 1234 |
| Kits | Kit 1235 |
| Mass Attributes | Target Weight |
| Mass Attributes | Weight Method |
| Mass Attributes | Weight Units of |
| | Measure |
| POC Attributes | Government POC |
| POC Attributes | LM POC |
| Reliability and | Fault Detection |
| Maintainability Attributes | |
| Reliability and | Fault Isolation |
| Maintainability Attributes | |
| Reliability and | MFHBF-DC |
| Maintainability Attributes | |
| Reliability and | MMH/FH |
| Maintainability Attributes | |
| Reliability and | MTBF |
| Maintainability Attributes | |
| Reliability and | MTTR |
| Maintainability Attributes | |
| Software | A/C Loadable |
| Software | Box Loadable |
| Software | DEV/MOD/NDI/COTS |
| Software | MFD Code |
| Software | Version |

FIG. 1 illustrates a low-level component diagram 80. Beginning at the left side, the user requests data from the system. Next, the system proceeds through a Single Sign On System (SiteMinder) 85 that manages authentication across other systems. After SiteMinder 85, the WebIDE Portal 90 is reached and requests are made of the various components of the System Models Portlet 95. The entities contained within the System Models Portlet box represent different code modules (classes) of the implemented navigator. The System Models Portlet Database 100 (second to rightmost component) should also be considered part of the navigator as it provides the data storage for model data.

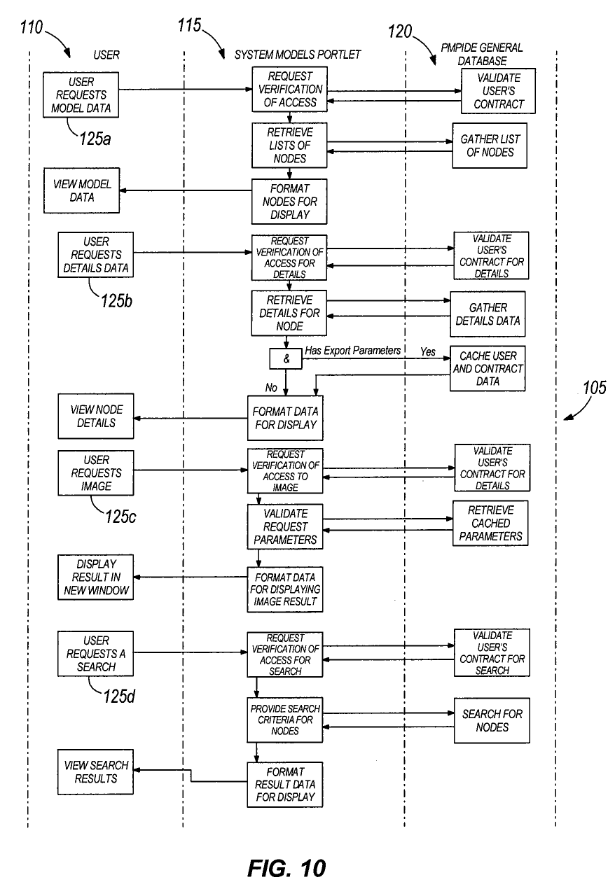

FIG. 10 illustrates an activity diagram 105 that conveys a top-level program flow for the navigator. It is organized into “swim lanes,” with one lane for each major component. In this case there are three major components, the user's actions 110, the view system (System Models Portlet) 115, and the database store 120 for the model data (PMPIDE_General database). Down the user column 110 are presented four different user actions 125a-125d. The activities that flow from these initial actions 125a-125d diagram the program flow.

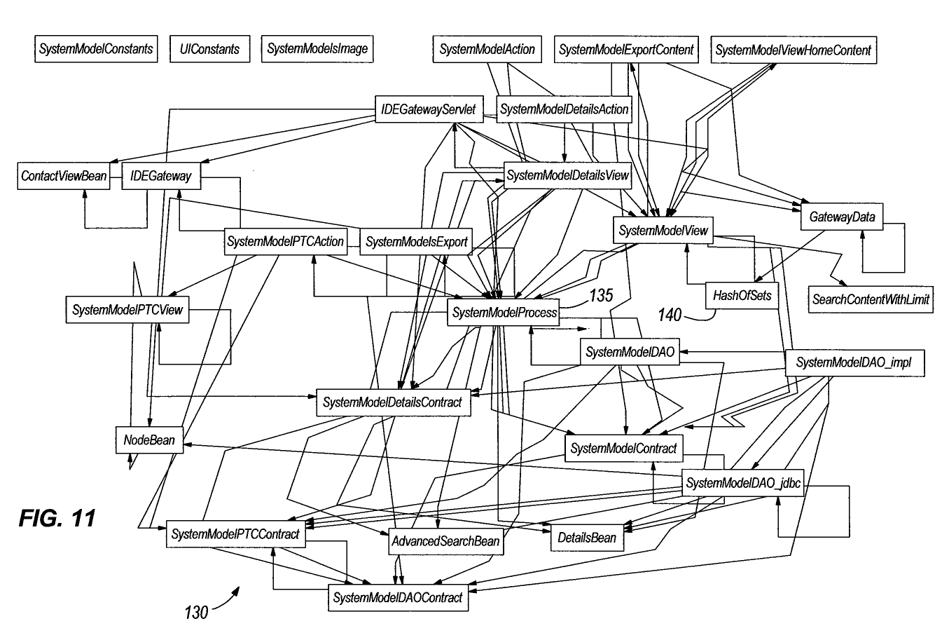

FIG. 11 illustrates a class diagram 130 that lists the lowest level code module (class) names and diagrams their interaction. It can be seen that classes such as SystemModelProcess 135 are at the center of a large web of relationships with the other code modules, where as the HashOfSets class 140 (middle, right) has only a few dependencies with other classes.

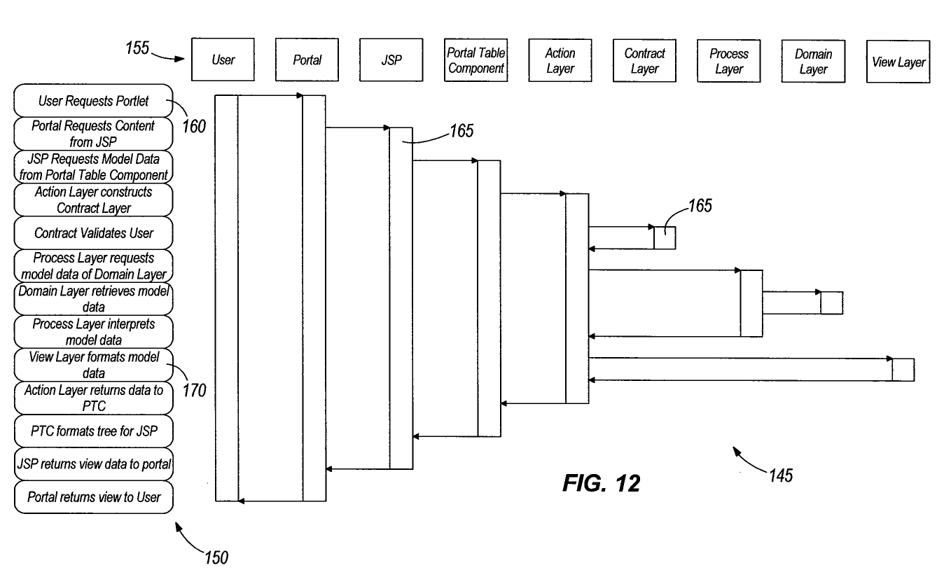

FIG. 12 illustrates a sequence diagram 145 that shows the detailed flow through the navigator. The major steps of execution 150 are listed down the left and the components involved 155 are listed across the top. Beginning with the user request 160, the portal next requests content from JSP layer. It is apparent that the gray boxes of execution time 165 correspond to the respective step being executed. For example, a very short step, “View formats the model data” 170 on the right hand side, has a short execution box 165.

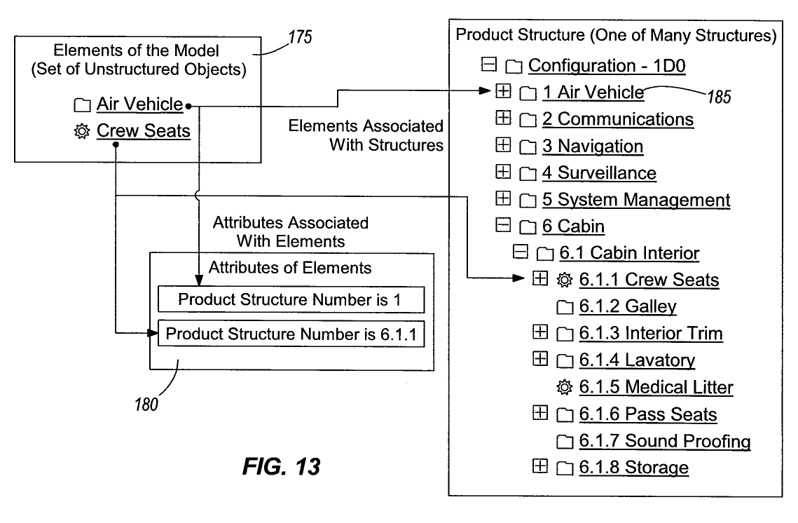

FIG. 13 is a diagram that illustrates the concept of an unstructured set of model data having attributes associated with it and being incorporated into a structure. In this example, Crew Sets 175a and Air Vehicle 175b are objects in the model that have respective values for a Product Structure Number attribute 180. Furthermore, as shown in the right box, they are given positions within a Product Structure organization based on the Product Structure Number attribute 180.

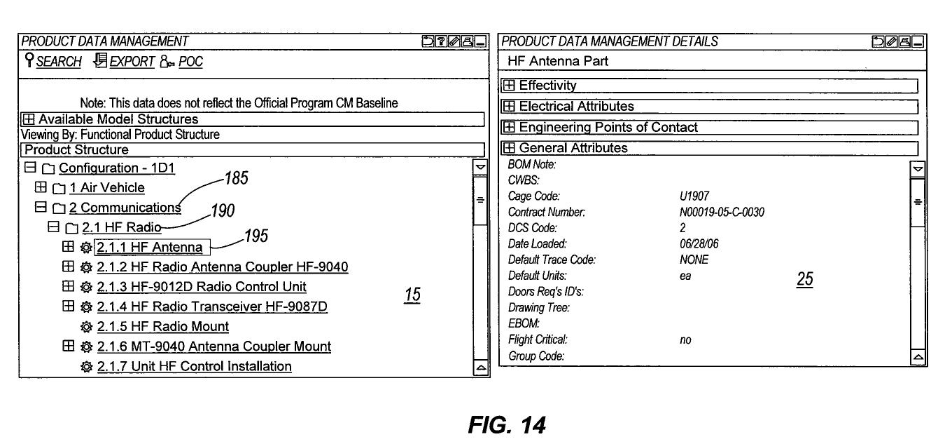

FIGS. 14 and 15 illustrate two screens in which the data model structures are different. In FIG. 14, the model structure is arranged by the Functional Product Structure. In this window, the user has drilled down or navigated through the communications node 185 and the HF Radio node 190 to reach the HF antenna element 195. The details for the HF antenna part are displayed in the detail portlet 25 of FIG. 14.

FIG. 15 illustrates the model structure arranged by logistic control number (LCN). In this window, the user has navigated into the 2310 control number 200 and has selected the HF antenna 195. The details for the HF antenna part are displayed in the detail portlet 25 of FIG. 15. Thus, two different users, using two different model structures, were able to easily find the attributes of the same HF antenna part.

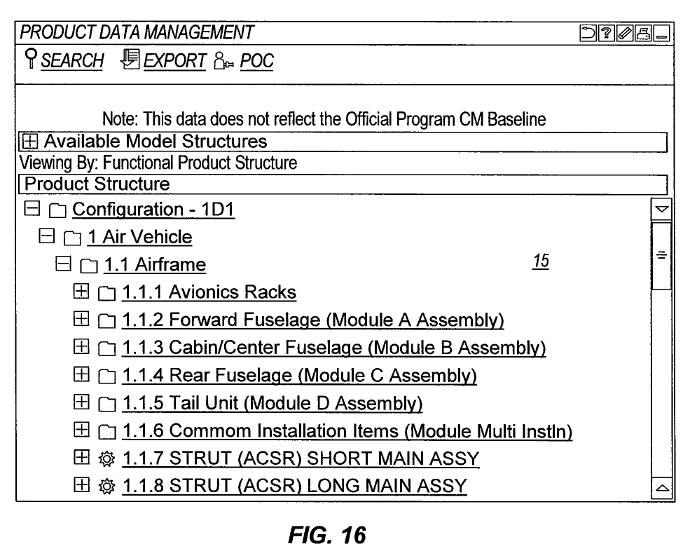

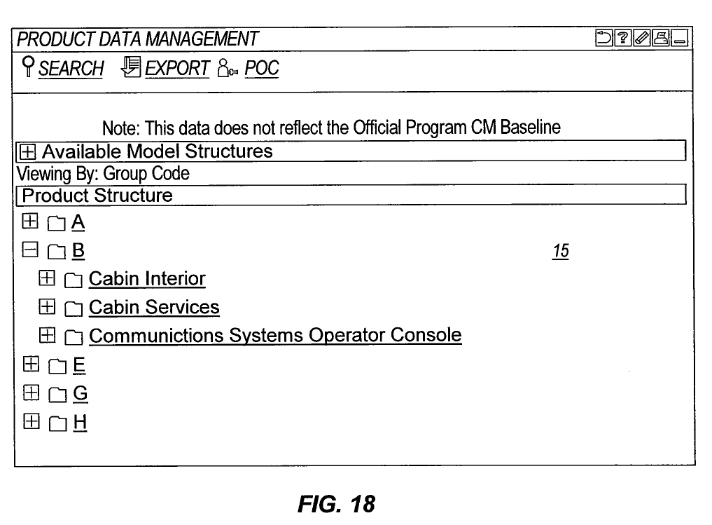

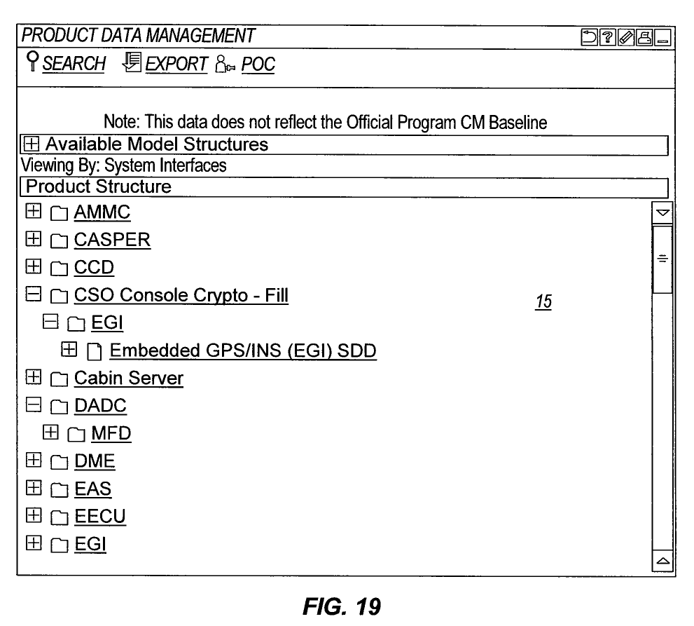

FIGS. 16-19 illustrate examples of a portion of the home screen 10 with the model structure arranged in different ways. FIG. 16 illustrates the model structure arranged by functional product structure. FIG. 17 illustrates the model structure arranged by logistic control number. FIG. 18 illustrates the model structure arranged by group code. FIG. 19 illustrates the model structure arranged by system interfaces. While four different model structures are illustrated herein, one of ordinary skill in the art will realize that other model structures and arrangements are possible.

In preferred constructions, the navigator computes the structure based on the attributes for a particular part. Thus, the navigator organizes any new data or new elements with little or no user intervention. For example, if a new part is inserted into the database and given an LCN in the LCN attribute field, the navigator automatically places the part in the proper folder when the model structure is arranged by LCN as illustrated in FIGS. 15 and 17.

Thus, the invention provides, among other things, a new and useful structured model navigator. More particularly, the invention relates to a computer program that facilitates the organization of structured model data in various ways according to the user.

What is claimed is:

1. A system for organizing and searching data that relates to a product of manufacture, the system comprising:
a database module configured to store values for a plurality of attributes for each of a plurality of components, a portion of the plurality of components employed in the product of manufacture;
a processing module configured to organize the plurality of components into one of a plurality of user selectable product structures, each product structure based on the values of one of the plurality of attributes; and
a display configured to display the selected product structure of the article of manufacture with each of the components displayed within the selected structure.

2. The system of claim 1, further comprising a search module configured to search the database module for data that meets a search criterion.

3. The system of claim 2, further comprising a user interface configured to accept user input of the search criterion.

4. The system of claim 3, wherein the display is configured to display search results in one of a plurality of user selectable formats.

5. The system of claim 3, wherein the display is configured to display search results in the selected product structure, wherein product structure that includes data that meets the search criterion is highlighted.

6. The system of claim 3, wherein the plurality of attributes includes a functional product structure, a control number, and system interfaces.

7. A method of interacting with data related to components that are used to assemble an article of manufacture, the method comprising:
establishing a database including data describing a plurality of components used to assemble the article of manufacture;
assigning a value to each of a plurality of attributes for each of the plurality of components;
organizing the components into a structure based on the values of one of the plurality of attributes; and
displaying the structure in a hierarchal fashion based on the one of the plurality of attributes.

8. The method of claim 7, further comprising providing a user interface and allowing a user to select one of a plurality of product structures each based on one of the plurality of attributes.

9. The method of claim 7, further comprising executing a search for components based on a second of the plurality of attributes.

10. The method of claim 9, further comprising providing a user interface and allowing a user to enter a search criterion via the user interface.

11. The method of claim 10, further comprising displaying the search results in a hierarchal fashion based on the first of the plurality of attributes.

12. The method of claim 11, further comprising highlighting a structural element that includes data corresponding to the search criterion.

13. The method of claim 7, wherein the plurality of attributes includes a functional product structure, a control number, and system interfaces.

14. The method of claim 7, wherein the step of organizing the components into a structure based on the values of one of the plurality of attributes further comprises organizing the structure based on the values of a first of the plurality of attributes and the values of a second of the plurality of attributes.

15. The method of claim 7, further comprising inputting a user inclusion rule including an attribute and a non-attribute, and organizing the components into a structure based on the value of the attribute and the non-attribute.

16. A graphical user interface configured to be displayed on a computer system for informing a user about selected search results of data related to an article of manufacture, the graphical user interface comprising:
a search results view pane including a drop down list of user selectable views for selecting a results view;
a search pane including a plurality of search criteria windows for the user to input search criteria; and
a search results pane that displays search results arranged in a view based on the user selectable view selected in the search results view pane.

17. The graphical user interface of claim 16, wherein the search results view pane includes a drop down list of the available views.

18. The graphical user interface of claim 16, wherein the search pane includes a keyword search window and an advanced search expandable pane.

19. The graphical user interface of claim 18, wherein the advanced search expandable pane includes a plurality of search windows, and wherein each window relates to one of the plurality of attributes.

20. The graphical user interface of claim 16, wherein the plurality of attributes includes a functional product structure, a control number, and system interfaces.
